(19) United States
(12) Patent Application Publication
(10) Pub. No.: US 2024/0186626 A1
(43) Pub. Date: Jun. 6, 2024

(54) BATTERY

(71) Applicants: PRIMEARTH EV ENERGY CO., LTD., Kosai-shi (JP); TOYOTA JIDOSHA KABUSHIKI KAISHA, Toyota-shi (JP); Prime Planet Energy & Solutions, Inc., Tokyo (JP)

(72) Inventors: Shigeru MATSUMOTO, Toyohashi-shi (JP); Yozo UCHIDA, Toyota-shi (JP); Tsuyoshi EHARA, Toyota-shi (JP); Yuki SATO, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); Prime Planet Energy & Solutions, Inc., Tokyo (JP)

(21) Appl. No.: 18/381,431

(22) Filed: Oct. 18, 2023

(30) Foreign Application Priority Data
Dec. 1, 2022 (JP) 2022-192914

(51) Int. Cl. H01M 50/184; H01M 50/103; H01M 50/176; H01M 50/188; H01M 50/193

(52) U.S. Cl. CPC H01M 50/184; H01M 50/103; H01M 50/176; H01M 50/188; H01M 50/193

(57) ABSTRACT

A battery includes: an outer casing accommodating a power generating element; and a terminal member connected thereto and having a terminal surface exposed outside the outer casing. The battery further includes a conductive closing member formed with a through hole for the terminal member, and an insulating sealing resin member closing a gap between the closing member and the terminal member over the entire perimeter of the through hole. The outer surface of the sealing resin member outside the closing member is defined by an outward-facing portion connected to the terminal member and a sloped portion continuous with and more steeply sloped than the outward-facing portion to have a height from an outer surface of the closing member, smaller toward a farther side from the terminal member. Those outward-facing portion and sloped portion are provided outside an outer edge of the terminal surface over the entire perimeter thereof.

### CROSS-REFERENCE TO RELATED APPLICATIONS

This application is based upon and claims the benefit of priority to Japanese Patent Application No. 2022-192914 filed on Dec. 1, 2022, the entire contents of which are incorporated herein by reference.

### BACKGROUND

### Technical Field

The present disclosure relates to a battery.

### Related Art

A conventionally known battery is provided with an outer casing and a terminal inserted through an insertion hole of the outer casing. For example, a battery disclosed in Japanese unexamined patent application publication No. 2019-091656 (JP 2019-091656A) is configured such that a gap between the terminal and the outer casing is filled with an insulating resin member.

### SUMMARY

### Technical Problems

The above-described conventional art has a problem that liquid is liable to accumulate on the outer surface of the outer casing. The resin member that fills the gap between the terminal and the insertion hole of the outer casing includes an exposed portion, which is exposed outside the outer casing and has a wall surface standing almost perpendicular to the outer surface of the outer casing, for example. If dew condensation occurs on the outer surface of a battery due to changes in environmental temperature, for instance, dew condensation water tends to collect in the corner between the outer surface of the outer casing and the wall surface of the resin member due to the surface tension of the water. This accumulation of water on the outer surface of the outer casing may cause short circuits or other defects.

JP 2019-091656A discloses a power storage device provided with a tapered connecting portion between a surrounding portion and a first contact portion. In this power storage device, both the surrounding portion and the first contact portion, which are connected to each other by the connecting portion, are part of a support part made of resin. In other words, this connecting portion does not connect an insulating resin member and a conductive outer casing. Thus, the connecting portion is not located in a position where water could accumulate and cause tracking.

The present disclosure has been made to address the above problems and has a purpose to provide a battery configured to prevent liquid accumulation on the outside of an outer casing.

### Means of Solving the Problems

To solve the above problems, one aspect of the present disclosure provides a battery comprising: a power generating element; an outer casing internally accommodating the power generating element; a terminal member connected to the power generating element inside the outer casing, the terminal member including a terminal surface exposed outside the outer casing; a conductive closing member that is a part of the outer casing and includes a through hole through which the terminal member is inserted; and an insulating sealing resin member that closes a gap between the closing member and the terminal member over an entire perimeter of the through hole, wherein the sealing resin member has an outer shape, outside the closing member, defined by: an outward-facing portion connected to an outer perimeter of the terminal member; and a sloped portion located outside and continuous with the outward-facing portion, the sloped portion being more steeply sloped than the outward-facing portion so that a height from an outer surface of the closing member is smaller toward a farther side from the terminal member, and the outward-facing portion and the sloped portion are provided outside an outer edge of the terminal surface over an entire perimeter of the terminal surface.

In the battery configured as above, the sealing resin member insulates between the closing member, which is a part of the outer casing, and the terminal member. The outer shape of the sealing resin member, outside the closing member, is defined by the outward-facing portion and the sloped portion outside this outward-facing portion so that the height of the sloped portion (i.e., the thickness of the sealing resin member) from the outer surface of the closing member is smaller toward a farther side from the terminal member. In other words, a part of the sealing resin member, located in contact with the outer surface of the closing member, is smaller in thickness than the rest part, resulting in a reduced space where liquid may accumulate. In the thus configured battery, liquid is less likely to accumulate on the outer surface of the outer casing.

### BRIEF DESCRIPTION OF THE DRAWINGS

FIG. 1 is a perspective external view of a battery in an embodiment;

FIG. 2 is a perspective view of a closing member and terminal members of the battery shown in FIG. 1;

FIG. 3 is a cross-sectional view of one of the terminal members, and its surroundings;

FIG. 4 is a plan view of the terminal member and its surroundings shown in FIG. 3;

FIG. 5 is an enlarged cross-sectional view showing one example of the shape of a sealing resin member;

FIG. 6 is an explanatory diagram showing an example of an angle of a sloped portion of the sealing resin member;

FIG. 7 is an explanatory diagram showing an example of a cross-sectional shape of the sealing resin member;

FIG. 8 is an explanatory diagram showing another example of the cross-sectional shape of the sealing resin member;

FIG. 9 is an explanatory diagram showing another example of the cross-sectional shape of the sealing resin member;

FIG. 10 is a plan view of a terminal member and its surroundings in a modified example; and

FIG. 11 is an explanatory diagram showing another example of the cross-sectional shape of the sealing resin member.

### DETAILED DESCRIPTION OF THE EXEMPLARY EMBODIMENTS

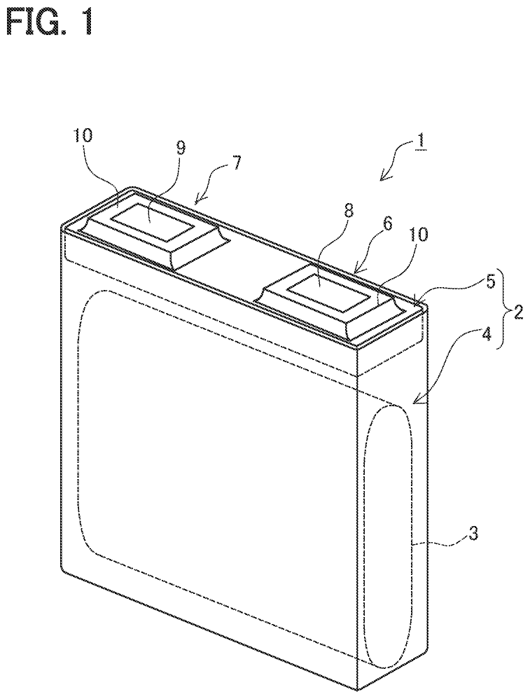

A detailed description of an embodiment of this disclosure will now be given referring to the accompanying drawings. A battery 1 in the present embodiment is a secondary battery, mainly including a power generating element 3 accommodated in an outer casing 2, as shown in FIG. 1.

The outer casing 2 consists of a casing body 4 and a closing member 5 as shown in FIG. 1. This battery 1 has an overall flat rectangular outer shape. In FIG. 1, the closing member 5 is located on the top of the casing body 4 and provided with a positive external terminal 6 and a negative external terminal 7, which are located near both ends in the longitudinal direction. At the locations of the external terminals 6 and 7, terminal members 8 and 9 are respectively fixed to the closing member 5 via sealing resin members 10. The terminal members 8 and 9 each have a surface (facing upward in FIG. 1) that is exposed outside the outer casing 2 and forms a terminal surface for connection to another battery, etc.

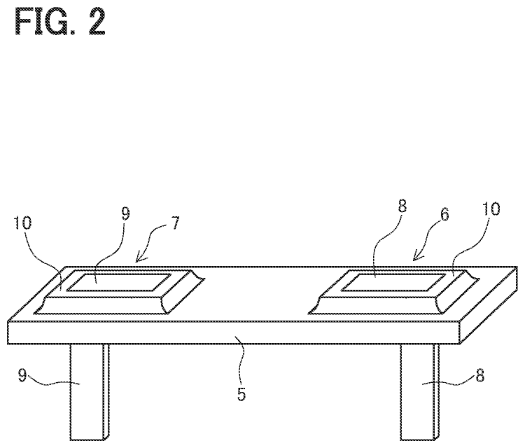

FIG. 2 shows the closing member 5 containing the external terminals 6 and 7 of the battery 1 shown in FIG. 1. The closing member 5 illustrated in FIG. 2 is at the stage where the terminal members 8 and 9 are fixed to the closing member 5 via the sealing resin members 10. The closing member 5 is provided with through holes at the locations corresponding to the external terminals 6 and 7, in which the terminal members 8 and 9 are respectively inserted to penetrate through the through holes. In the battery 1 in FIG. 1, lower ends of the terminal members 8 and 9 in FIG. 2 are connected respectively to positive and negative electrode plates of the power generating element 3, inside the outer casing 2. The battery 1 is configured such that the power generating element 3 is accommodated in the casing body 4, and the closing member 5 is joined to the casing body 4.

Each of the terminal members 8 and 9 is a metal member or an alloy member, which may be made mainly of aluminum, copper, etc. The outer casing 2 is also a metal member or an alloy member, which may be made mainly of aluminum, stainless steel, etc. Specifically, the terminal members 8 and 9 and the closing member 5 that is a part of the outer casing 2 are all conductive members. In and around a gap between the closing member 5 and each of the terminal members 8 and 9, the sealing resin member 10 made of insulating synthetic resin is provided.

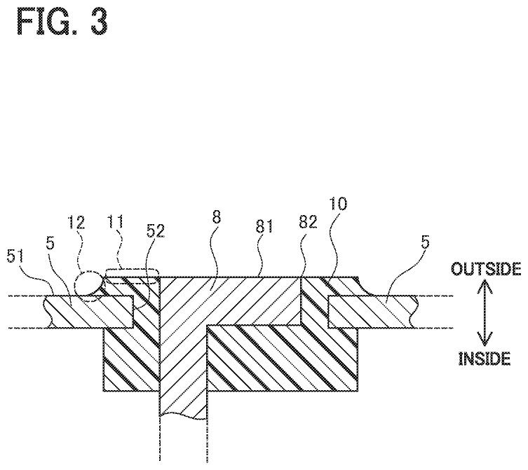

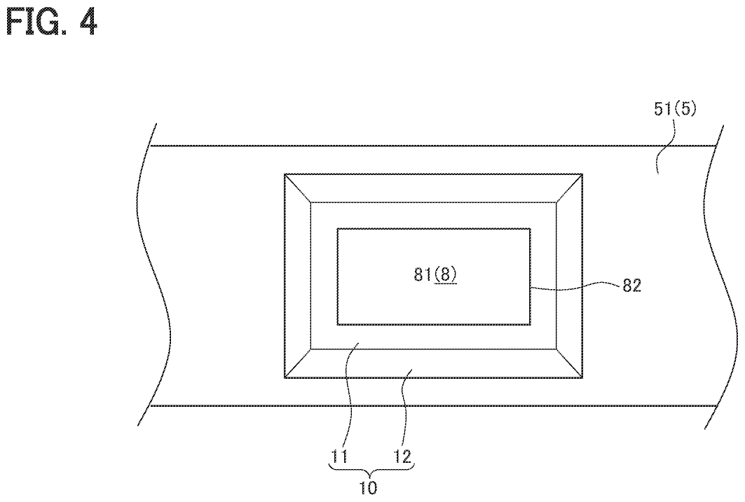

The terminal member 8 and its surroundings in the closing member 5 are shown in FIGS. 3 and 4. Specifically, FIG. 3 is a cross-sectional view illustrating the terminal member 8 and its surroundings, in which the outside of the battery 1, i.e., the outside of the outside of the closing member 5, is on the upper side, and the inside of the battery 1 is on the lower side, as indicated by a double-headed arrow in the figure. FIG. 4 is a plan view illustrating the the terminal member 8 and its surroundings viewed from the outside in FIG. 3. In the following description and each figure, the terminal member 8 and its surroundings will be described, but the terminal member 9 has the same configuration as the terminal member 8 and its details are omitted.

As shown in FIG. 3, the closing member 5 is formed with a through hole 52 through which the terminal member 8 extends. This terminal member 8 is placed at a position penetrating through the through hole 52 but not contacting the closing member 5, with a terminal surface 81 protruding to the outside of the battery 1 relative to the outer surface 51 of the closing member 5. In and around the gap between the terminal member 8 and the closing member 5, the sealing resin member 10 is provided along the entire perimeter of the through hole 52. This sealing resin member 10 insulates between the terminal member 8 and the closing member 5.

As shown in FIGS. 3 and 4, the outer surface 51 of the closing member 5, the terminal surface 81 of the terminal member 8, and a part of the sealing resin member 10 are exposed outside the battery 1. The terminal surface 81 is planar. The exposed part of the sealing resin member 10 is provided around an outer edge 82 of the terminal surface 81 over its entire perimeter, as shown in FIG. 4. The outer edge 82 is the outer perimeter of the terminal surface 81, which is defined for example a rectangular frame line in FIG. 4. The sealing resin member 10 has, on the outside of the closing member 5, an outer shape defined by an outward-facing portion 11 and a sloped portion 12. Specifically, the outward-facing portion 11 is connected to the outer edge 82 and provided along the entire perimeter of the outer edge 82, and the sloped portion 12 is provided outside and continuous with the outward-facing portion 11 and extending along the entire perimeter of the outward-facing portion 11, as shown in FIGS. 3 and 4.

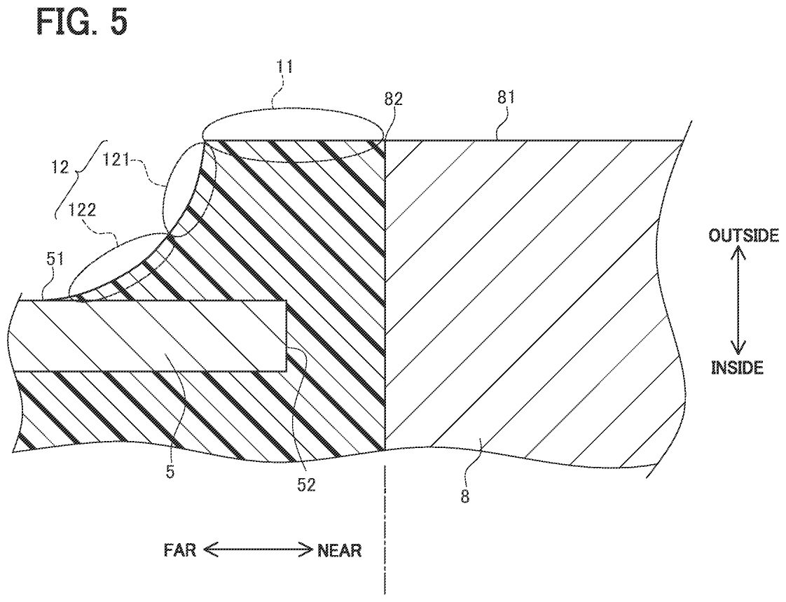

The shapes of the outward-facing portion 11 and sloped portion 12 are shown in detail in a cross-sectional view of FIG. 5, in which the upper side in the figure corresponds to the outside of the battery 1 and the lower side in the figure corresponds to the inside of the battery 1, as indicated by a double-headed vertical arrow in FIG. 5. In FIG. 5, furthermore, the right side corresponds to the near side to the terminal member 8 and the left side corresponds to the far side from the terminal member 8, as indicated by a double-headed horizontal arrow in the figure. In FIG. 5, the upper side relative to the outer surface 51 of the closing member 5 corresponds to the outside of the closing member 5. Further, the left side relative to the outer edge 82 of the terminal member 8 and its extension in FIG. 5 corresponds to the outside of the terminal member 8.

As shown in FIG. 5, the outward-facing portion 11 has a planar shape substantially flush with the terminal surface 81. The sloped portion 12 includes a steeply-sloped portion 121 and a gently-sloped portion 122. Both the steeply-sloped portion 121 and the gently-sloped portion 122 are provided around the terminal surface 81 over its entire perimeter. The steeply-sloped portion 121 is continuous with the outward-facing portion 11 and has a height from the outer surface 51 of the closing member 5, smaller toward the farther side from the terminal member 8 than the outward-facing portion 11. The gently-sloped portion 122 is continuous with the steeply-sloped portion 121 and has a height from the outer surface 51 of the closing member 5, smaller toward the farther side from the terminal member 8, i.e., toward the opposite side to the steeply-sloped portion 121, than the steeply-sloped portion 121. This gently-sloped portion 122 has an outer edge located on the far side from the terminal member 8 is connected to the outer surface 51 of the closing member 5. In FIG. 5, those steeply-sloped portion 121 and gently-sloped portion 122 are each enclosed by broken lines, but the boundary between the steeply-sloped portion 121 and the gently-sloped portion 122 may be defined arbitrarily.

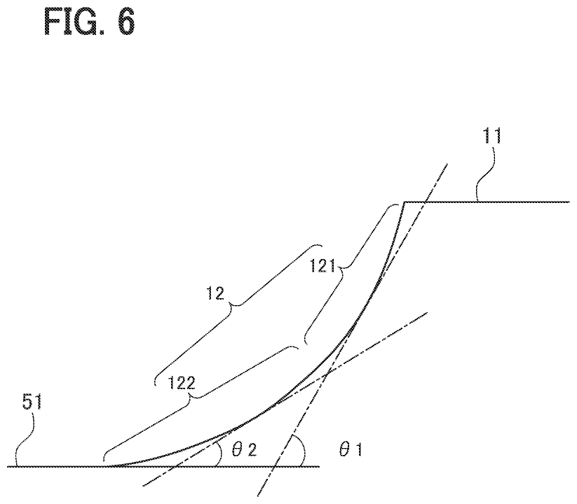

FIG. 6 shows one example of the slope angles of the steeply-sloped portion 121 and gently-sloped portion 122. As shown in FIG. 6, the slope angle θ1 between the outer surface 51 of the closing member 5 and the steeply-sloped portion 121 is smaller than 90° but larger than the slope angle θ2 between the outer surface 51 and the gently-sloped portion 122. In other words, the gently-sloped portion 122 is sloped more gently than the steeply-sloped portion 121 and connected to the outer surface 51 at a gentle angle. FIG. 6 shows the slope angles with respect to the outer surface 51, but the slope angle of the steeply-sloped portion 121 to the outward-facing portion 11 or the terminal surface 81 is similarly larger than the slope angle of the gently-sloped portion 122.

The sealing resin member 10 including the outward-facing portion 11 allows a part of the terminal member 8, located outside the battery 1 relative to the outer surface 51 of the closing member 5, to be reliably held to the closing member 5. Furthermore, the sealing resin member 10 including the sloped portion 12 prevents liquid from accumulating at and around the boundary between the closing member 5 and the sealing resin member 10 as compared with a sealing resin member in which an outward-facing portion has a perimetrical surface standing perpendicularly from an outer edge to the outer surface 51 of the closing member 5. The sealing resin member 10 configured as above covers a wider area of the outer surface 51 as compared with the sealing resin member including the outward-facing portion 11 alone, i.e., including no sloped portion, resulting in a longer distance between an exposed part of the terminal member 8 and an exposed part of the closing member 5, and also a longer creepage distance formed by the sealing resin member 10 serving as the insulating member interposed between the terminal member 8 and the closing member 5, thus exhibiting more excellent insulation properties.

The sealing resin member 10 is formed by for example insert molding. Specifically, the closing member 5 with the terminal members 8 and 9 inserted through the through holes 52 is set in a mold, and molten synthetic resin is injected into the mold to form the sealing resin member 10 shown in FIG. 2. The shape of the sealing resin member 10 illustrated in FIG. 2 and others is obtained by the shape of a mold cavity used for insert molding.

The sloped portion 12 may have a cross-sectional shape defined by an arc-shaped concave-curved surface with a uniform curvature between the steeply-sloped portion 121 and the gently-sloped portion 122, that is, a cylindrical surface, or a splined concave-curved surface with a curvature that changes at a certain point. Since the gently-sloped portion 122 is shaped with such a concave-curved surface sloped more gently toward a farther side from the terminal member 8, the sloped portion 12 can have a smaller angle at the outer edge with respect to the outer surface 51 without increasing the distance on the outer surface 51 from the terminal member 8 to the outer edge of the sealing resin member 10.

The sloped portion 12 described above is configured to include the steeply-sloped portion 121 and the gently-sloped portion 122, but does not have to be clearly divided into those two portions, that is, the sloped portion 12 may be configured with a uniform slope. However, the sloped portion 12 including the steeply-sloped portion 121 and the gently-sloped portion 122 as mentioned above can easily achieve a reduced angle between the outer edge of the sloped portion 12 and the outer surface 51.

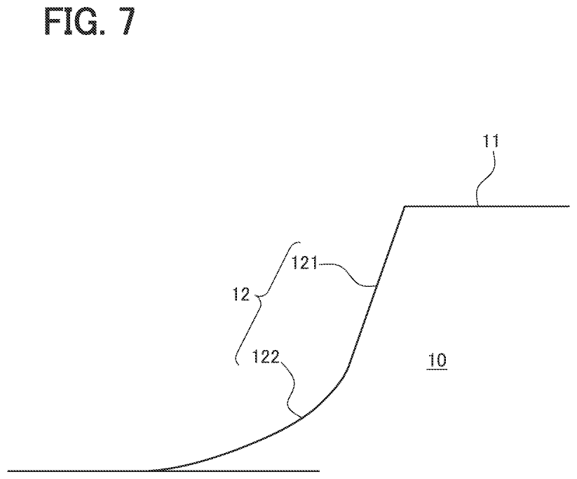

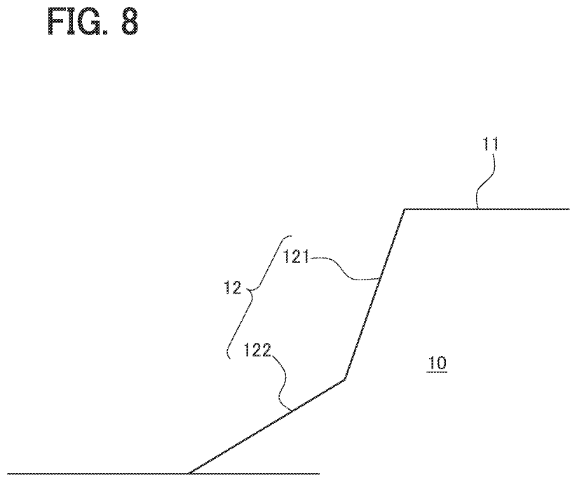

The cross-sectional shape of the sloped portion 12 is not limited to the shape with the continuous concave-curved surface as shown in FIGS. 5 and 6. As an example, as shown in FIG. 7, the sloped portion 12 can be designed with a cross-sectional shape such that a steeply-sloped portion 121 having a planar surface is continuous with a gently-sloped portion 122 having a concave-curved surface. As another example, as shown in FIG. 8, the sloped portion 12 can be designed with a cross-sectional shape such that a steeply-sloped portion 121 and a gently-sloped portion 122, each having a planar surface, are continuous with each other. In each of the above examples, the steeply-sloped portion 121 and gently-sloped portion 122 are more steeply sloped than the outward-facing portion 11, and further the gently-sloped portion 122 is more gently sloped than the gently-sloped portion 122.

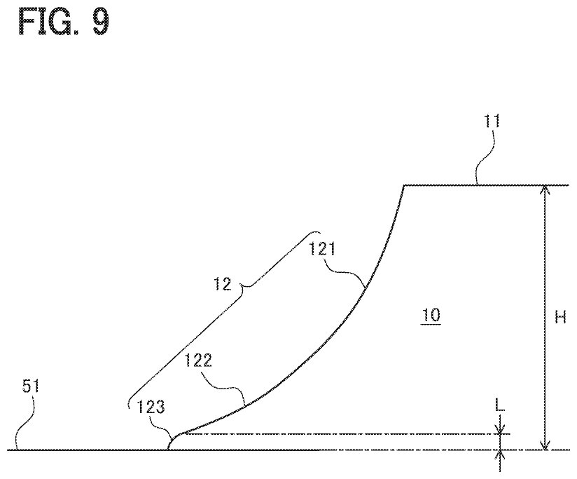

As still another example, as shown in FIG. 9, the sloped portion 12 may include a step portion 123 located outside, i.e., around, the gently-sloped portion 122 and continuous with the gently-sloped portion 122. This step portion 123 has a convex curved surface more steeply sloped than the gently-sloped portion 122. For instance, a slight step portion may occur unintentionally due to the reasons in manufacture. However, the height L of the step portion 123 from the outer surface 51 may be, for example, less than a quarter of the vertical distance H between the outer surface 51 and the surface of the outward-facing portion 11. Even if such a small step portion 123 exists, it hardly generates a space where liquid may accumulate between the closing member 5 and the sealing resin member 10, and thus the liquid is less likely to collect around the step portion 123.

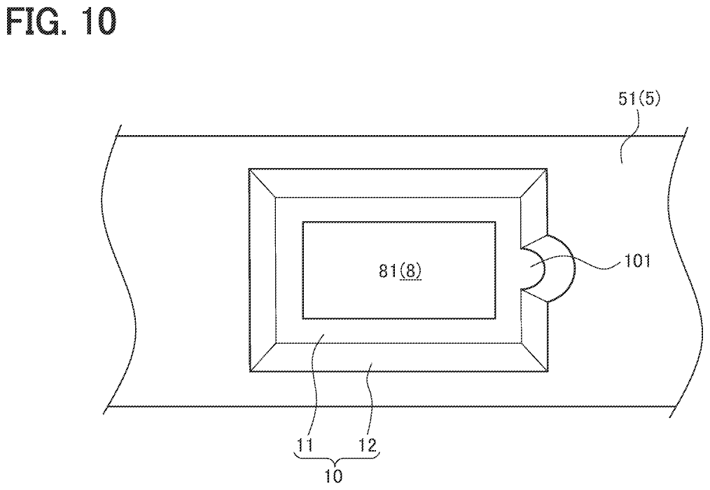

The sealing resin member 10 has only to be provided over the entire perimeter of the terminal surface 81 of the terminal member 8. The shape of terminal surface 81 and the shape of sealing resin member 10 in plan view are not limited to the rectangular shape shown in FIG. 4. For example, the shape of the terminal surface 81 can be rounded-rectangular, square, circular, elliptic, or others, as well as rectangular. Further, the sealing resin member 10 is not limited to having a uniform width over the entire perimeter of the terminal surface 81, but may include, for example, a partial protruding portion 101 shown in FIG. 10, or a partial recessed portion.

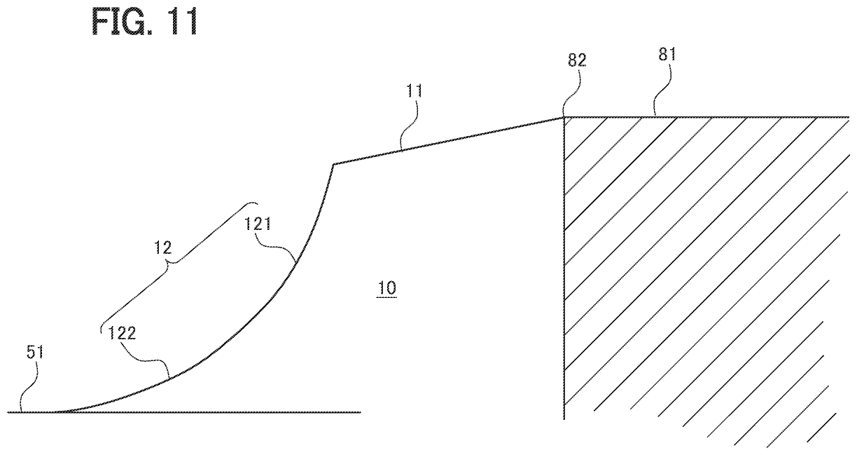

The outward-facing portion 11 described above is flush with the terminal surface 81, but may be configured to slope downward from the outer edge 82 toward the outer surface 51, more gently than the sloped portion 12, as shown in FIG. 11. The outward-facing portion 11 and the sloped portion 12 may be smoothly continuous with each other, instead of having an angular borderline.

In the battery 1 in the present embodiment described in detail above, the sealing resin member 10 insulates between the closing member 5 and the terminal members 8 and 9. The part of each sealing resin member 10, outside the closing member 5, has the outer shape defined by the outward-facing portion 11 connected to the outer perimeter of the terminal member 8 or 9 and the sloped portion 12 whose height from the outer surface 51 of the closing member 5 is smaller toward the farther side from the terminal member 8 or 9, i.e., toward the opposite side from the outward-facing portion 11. This configuration hardly forms a space where liquid may accumulate at and around the boundary between the sealing resin member 10 and the closing member 5, so that liquid is unlikely to collect around the outer casing 2.

The foregoing embodiment is a mere example and give no limitation to the present disclosure. The present disclosure may be embodied in other specific forms without departing from the essential characteristics thereof. For example, the type of the battery 1 is not particularly limited to a specific one, but may be selected from a lithium-ion secondary battery, a nickel-metal hydride battery, or other types. Moreover, for example, the outer shape of the battery 1, the shape of the power generating element 3, the locations of the external terminals 6 and 7 are not limited to the examples shown in the figures.

In the foregoing embodiment, the sealing resin members 10 of the same shape are provided around the terminal members 8 and 9, but not limited thereto. The present disclosure may be applied to only one of the terminal members 8 and 9. Alternatively, the sealing resin members 10 of different shapes may be provided around the terminal members 8 and 9.

For example, in FIG. 3, the terminal surface 81 and the outward-facing portion 11 of the sealing resin member 10 are flush with each other, but the terminal surface 81 may protrude outward relative to the sealing resin member 10. Further, for example, in FIG. 3, the terminal member 8 has an L-shaped cross-section, but the shapes of the terminal members 8 and 9 are not limited thereto.

The battery according to the present disclosure may be configured such that the sloped portion includes: a steeply-sloped portion continuous with the outside of the outward-facing portion; and a gently-sloped portion continuous with outside of the steeply-sloped portion, the gently-shaped portion having an outer edge connected to the outer surface of the closing member, the gently-sloped portion is sloped more gently than the steeply-sloped portion, and both the steeply-sloped portion and the gently-sloped portion are provided surrounding the terminal surface over the entire perimeter thereof. In this battery configured as above, the part of the sealing resin member, connected to the outer surface of the closing member, is more gently sloped, over the entire perimeter of the sealing resin member. This configuration hardly forms a space where liquid may accumulate at and around the boundary between the sealing resin member and the closing member, so that liquid is unlikely to accumulate between the closing member and the sealing resin member.

In the battery configured as above, furthermore, the gently-sloped portion has a shape with a concave-curved surface more gently sloping toward the farther side from the terminal member. In this battery, the sealing resin member can have a gentler slope than in the battery mentioned above without excessively increasing the distance from the terminal member to the outer edge of the sealing resin member.

According to the present disclosure, a battery with an outer casing unlikely to cause accumulation of liquid on the outside is provided.

### REFERENCE SIGNS LIST

1 Battery
2 Outer casing
3 Power generating element
5 Closing member
8 Terminal member
9 Terminal member
10 Sealing resin member
11 Outward-facing portion
12 Sloped portion

What is claimed is:

1. A battery comprising:
a power generating element;
an outer casing internally accommodating the power generating element;
a terminal member connected to the power generating element inside the outer casing, the terminal member including a terminal surface exposed outside the outer casing;
a conductive closing member that is a part of the outer casing and includes a through hole through which the terminal member is inserted; and
an insulating sealing resin member that closes a gap between the closing member and the terminal member over an entire perimeter of the through hole,
wherein the sealing resin member has an outer shape, outside the closing member, defined by:
an outward-facing portion connected to an outer perimeter of the terminal member; and
a sloped portion located outside and continuous with the outward-facing portion, the sloped portion being more steeply sloped than the outward-facing portion so that a height from an outer surface of the closing member is smaller toward a farther side from the terminal member, and
the outward-facing portion and the sloped portion are provided outside an outer edge of the terminal surface over an entire perimeter of the terminal surface.

2. The battery according to claim 1, wherein
the sloped portion includes:
a steeply-sloped portion continuous with the outside of the outward-facing portion; and
a gently-sloped portion continuous with outside of the steeply-sloped portion, the gently-shaped portion having an outer edge connected to the outer surface of the closing member,
the gently-sloped portion is sloped more gently than the steeply-sloped portion, and
both the steeply-sloped portion and the gently-sloped portion are provided surrounding the terminal surface over the entire perimeter thereof.

3. The battery according to claim 2, wherein the gently-sloped portion has a shape with a concave-curved surface more gently sloping toward the farther side from the terminal member.

4. The battery according to claim 2, wherein the outer shape of the sealing resin member, located outside the closing member, further includes a step portion located outside and continuous with the gently-sloped portion, the step portion having a convex curved surface more steeply sloped than the gently-sloped portion.

5. The battery according to claim 3, wherein the outer shape of the sealing resin member, located outside the closing member, further includes a step portion located outside and continuous with the gently-sloped portion, the step portion having a convex curved surface more steeply sloped than the gently-sloped portion.
